(19) United States
(12) Patent Application Publication
(10) Pub. No.: US 2026/0091397 A1
(43) Pub. Date: Apr. 2, 2026

(54) PERFORMANCE AND RELIABILITY MONITORING OF A CENTRIFUGE

(71) Applicant: Honeywell International Inc., Charlotte, NC (US)

(72) Inventors: Mukund Joshi, Pune (IN); Vikas Mahule, Balaghat (IN); Vikram Singh Vaish, Bangalore (IN); Venkata Rao Venkamsetty, Bangalore (IN); Vaibhav Kamath, Hariharapura (IN); Harikrishnan Ravindranathan, Ernakulam (IN); Ronu Vikas Bhamarde, Gondia (IN)

(21) Appl. No.: 18/903,007

(22) Filed: Oct. 1, 2024

(51) Int. Cl. B04B 13/00; G01M 99/00

(52) U.S. Cl. CPC B04B 13/00; G01M 99/005

(57) ABSTRACT

Techniques for optimizing performance and reliability of a centrifuge are described. In one aspect, operational parameters associated with the centrifuge are obtained to determine a plurality of key performance indicators (KPIs). Each KPI is compared with an expected KPI corresponding to the centrifuge and a deviation in performance of the centrifuge is determined. Based on the deviation determined, the operational parameters, and a plurality of threshold ranges, which include a predicted dynamic threshold range, a fault associated with the centrifuge is determined or a probability of occurrence of an event associated with the centrifuge is predicted, where the event is characterized by a discrepancy in operation of the centrifuge. Further, a performance report with recommended actions to address the fault and the probability of occurrence of an event is generated and issued to personnel of the facility for proactive maintenance.

### TECHNICAL FIELD

The present subject matter relates, in general, to performance and reliability monitoring, and in particular, to performance and reliability monitoring of a centrifuge in a facility.

### BACKGROUND

Centrifuges are widely used in various industries for separating materials of different densities through the application of centrifugal force. Centrifuges are widely utilized in various industrial applications, such as wastewater treatment, chemical processing, pharmaceutical manufacturing, biotechnology, mineral processing, and the like. The principle of operation involves spinning a mixture at high speeds to induce forces that lead to the separation of constituents. Throughout their operational lifetime, from installation to disposal, multiple factors associated with the centrifuge may lead to wear and tear, and aging of the centrifuge. Effective performance and reliability management of these centrifuges may contribute to the overall efficiency and productivity of industrial facilities.

### SUMMARY

Aspects of the present subject matter provide techniques for optimizing the performance and reliability of a centrifuge operating in a facility.

According to an example of the present subject matter, a method for optimizing performance and reliability of a centrifuge operating in a facility is provided. The method includes obtaining, by an assessment module, one or more operational parameters associated with the centrifuge through one or more sensing elements coupled to the centrifuge. On obtaining the one or more operational parameters, the method includes, determining, by the assessment module, a plurality of key performance indicators (KPIs) from at least the one or more operational parameters associated with the centrifuge and comparing each KPI amongst the plurality of KPIs with an expected KPI corresponding to the centrifuge to determine a deviation in performance of the centrifuge. Further, the method includes performing, by a fault analysis model, at least one of determining a fault associated with the centrifuge and predicting a probability of occurrence of at least one event associated with the centrifuge based on the one or more operational parameters, the deviation in performance of the centrifuge, and a plurality of threshold ranges, where the plurality of threshold ranges includes at least one predicted dynamic threshold range, and where the event is characterized by a discrepancy in operation of the centrifuge. The method further includes generating, by the fault analysis model, a performance report for the centrifuge based on at least one of the determined fault and the probability of occurrence of at least one event, where the performance report includes one or more recommended actions to address at least one of the fault and the probability of occurrence of at least one event, and providing the performance report to a personnel of the facility to address at least one of the fault and the probability of occurrence of at least one event.

According to another example of the present subject matter, a system for optimizing performance and reliability of a centrifuge operating in a facility is provided. The system includes an assessment module and a fault analysis model. The assessment module is to obtain one or more operational parameters associated with the centrifuge through one or more sensing elements coupled to the centrifuge, determine a plurality of key performance indicators (KPIs) from at least the one or more operational parameters associated with the centrifuge, and compare each KPI amongst the plurality of KPIs with an expected KPI value to determine a deviation in performance of the centrifuge. Further, the fault analysis model is to predict a probability of occurrence of at least one event associated with the centrifuge based on the one or more operational parameters, the deviation in performance of the centrifuge, and a plurality of threshold ranges, where the plurality of threshold ranges includes a predicted dynamic threshold range, and where the event is characterized by a discrepancy in operation of the centrifuge. The fault analysis model is to generate a performance report for the centrifuge based on the probability of occurrence of at least one event, where the performance report includes one or more recommended actions to address the probability of occurrence of at least one event and provide the performance report to a personnel of the facility to address the probability of occurrence of at least one event, where the fault analysis model is trained using historical data including one or more faults, symptoms corresponding to the one or more faults associated with one or more sub-systems of the centrifuge, one or more actions performed to overcome the faults, past operational parameters and past deviations in performance of the centrifuge.

According to another example of the present subject matter, a non-transitory computer readable medium containing program instruction for optimizing performance and reliability of a centrifuge operating in a facility is provided, that, when executed, causes the processor to obtain one or more operational parameters associated with the centrifuge through one or more sensing elements coupled to the centrifuge, determine a plurality of key performance indicators (KPIs) from at least the one or more operational parameters associated with the centrifuge, compare each KPI amongst the plurality of KPIs with an expected KPI value to determine a deviation in performance of the centrifuge, correlate the one or more operational parameters, the deviation in performance of the centrifuge and a historical fault pattern to predict a probability of occurrence of at least one event associated with the centrifuge, generate a performance report including at least the probability of occurrence of the at least one event associated with the centrifuge and one or more actions to address the probability of occurrence of the at least one event, and provide the performance report to a personnel of the facility to address the probability of occurrence of the at least one event associated with the centrifuge.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the drawings to reference like features and components.

FIG. 1 illustrates a supply chain network environment, in accordance with an example implementation of the present subject matter.

FIG. 2 illustrates an example supply chain network, in accordance with an example implementation of the present subject matter.

FIG. 3 illustrates a performance and reliability monitoring system, in accordance with an example implementation of the present subject matter.

FIG. 4 illustrates an example of performance monitoring of a centrifuge in an industrial plant, in accordance with an example implementation of the present subject matter.

FIG. 5 illustrates an example of performance and reliability monitoring of an industrial facility, in accordance with an example implementation of the present subject matter.

FIG. 6 illustrates another example of performance and reliability monitoring of an industrial facility, in accordance with an example implementation of the present subject matter.

FIG. 7 illustrates an example method for optimizing performance and reliability of a centrifuge operating in a facility, in accordance with an example implementation of the present subject matter.

FIG. 8 illustrates another example method for optimizing performance and reliability of a centrifuge operating in a facility, in accordance with an example implementation of the present subject matter.

FIG. 9 illustrates another example method for optimizing performance and reliability of a centrifuge operating in a facility, in accordance with an example implementation of the present subject matter.

FIG. 10 illustrates a non-transitory computer-readable medium for optimizing performance and reliability of a centrifuge operating in a facility, in accordance with an example of the present subject matter.

### DETAILED DESCRIPTION

The present subject matter relates to techniques of optimizing the performance and reliability of a centrifuge operating in a facility. Generally, a supply chain encompasses a network of facilities including plants, warehouses, distribution centers, logistic hubs, and the like, that collectively work to produce and deliver products and services to end consumers. These facilities, such as chemical processing plants, oil and gas refineries, food and beverage industrial plants, pharmaceutical manufacturing units, and the like, often house equipments, such as centrifuges, that are integral to their operations and productivity. Centrifuges are widely used across industries such as for separating materials of different densities through the application of centrifugal force. During the operational lifetime of these centrifuges, multiple factors associated with the centrifuge may lead to wear and tear, and aging of the centrifuge, which may result in performance deterioration, decline in operating efficiency, reduced throughput, and increasing operating costs. Consequently, centrifuges may experience various faults or failures, which may impact the separation capabilities of the centrifuge, as well as the overall efficiency of the facility.

Despite their extensive use across industries, traditional techniques employed in monitoring the performance of a centrifuge or assessing the health of the centrifuge are often generic in nature and fail to account for specific real-time operating conditions of the centrifuge. Given the intricate nature of centrifuges, assessing the performance and health of the centrifuge based on generic approaches may be inadequate. For example, in some known techniques, parameters such as vibration, thrust, and bearing temperatures are solely relied upon to monitor a condition of the centrifuge. However, this limited data would be insufficient for personnel of the facility, such as facility operators, to make informed decisions that can optimize the performance of the centrifuge, and in turn the operations of the overall facility. Additionally, the lack of process monitoring of the centrifuge in real-time leads to utilizing outdated operating regimes, consequently resulting in sub-optimal performance of the centrifuge and reduced productivity of the facility.

Moreover, when a fault or an issue arises, such techniques fall short in facilitating operators to identify the root cause of the problem in real time, thereby leading to prolonged troubleshooting times and extended durations of reduced performance or downtime. Furthermore, without comprehensive monitoring, it may be challenging to accurately predict when maintenance is required, detect latent inefficiencies in centrifuge operation, identify damage under unfavourable operating conditions, or detect violations of the nominal operating range and deviations from expected characteristics. Lack of such information may lead to either premature maintenance, leading to unnecessary downtime, or delayed maintenance, potentially causing equipment failure and unplanned shutdowns. Both these scenarios would result in decrease in the operational efficiency of the centrifuge and would increase the costs associated with unplanned maintenance and frequent occurrence of faults which could be pre-empted.

Accordingly, the present subject matter provides techniques for optimizing performance and reliability of a centrifuge operating in a facility. Techniques of the present subject matter provide real-time monitoring and analysis of operational parameters associated with the centrifuge, where data from centrifuges may be collected from sensors to determine key performance indicators (KPIs). The actual KPIs determined for the centrifuge at a given point of time are compared to an expected value, to identify performance deviations. In one example, historical centrifuge performance data may be leveraged to identify deviations in performance of the centrifuge. Based on the performance deviations, faults associated with the centrifuge may be determined, or the probability of occurrence of an event may be predicted, and the like. In one example, techniques of the present subject matter may also incorporate adaptive thresholds that may be updated dynamically based on the specific operating conditions and historical performance of the centrifuge to allow for more accurate detection of anomalies and potential issues, taking into account factors such as the age of the equipment, maintenance history, and varying operational demands. Accordingly, a performance report may be generated with recommended actions, and an estimate of the remaining useful life of the centrifuge. By providing comprehensive performance management and predictive maintenance capabilities, techniques of the present subject matter enable facility personnel to make informed decisions, optimize centrifuge operation, and improve the overall productivity of the facility.

In operation, multiple operational parameters, such as inlet pressure, inlet temperature, inlet volume flow, rotational speed, inlet feed data, and the like associated with the centrifuge may be obtained to determine multiple key performance indicators (KPIs) associated with the centrifuge. To assess the performance and the reliability of the centrifuge in real-time, in one example, each KPI from amongst the multiple KPIs determined for the centrifuge may be compared with an expected KPI to determine a deviation in performance of the centrifuge. On determining the deviation in performance of the centrifuge, based on the one or more operational parameters that are obtained in real time, the deviation in performance, and multiple threshold ranges, a fault associated with the centrifuge may be determined or a probability of occurrence of at least one event associated with the centrifuge may be predicted, where an event is characterized by a discrepancy in operation of the centrifuge. In one example, the multiple threshold ranges may include a predicted dynamic threshold range. The predicted dynamic threshold range may be determined based on the operational parameters and historical data. In one example, a baseline for operation of the centrifuge may be established based on historical data associated with the centrifuge, such as past operational parameters, past deviations in performance of the centrifuge, past failure patterns of the centrifuge, past threshold ranges for desired operation of the centrifuge. Based on the operational parameters obtained in real-time and the baseline established, the dynamic threshold range for monitoring the centrifuge may be predicted. Adaptive threshold adjustments based on historical and real-time data facilitate improving the accuracy of fault predictions over time. In one example, based on past events and responses from personnel of the facility, the predictive capabilities and recommendations may be continuously refined, thereby enhancing the system's ability to optimize centrifuge performance.

Further, on determining a fault associated with the centrifuge and the probability of occurrence of an event, a performance report may be generated for the centrifuge. The performance report may include one or more recommended actions to address at least one of the fault and the probability of occurrence of the predicted event. In one example, the performance report include a current operating point of the centrifuge as well as an expected operating point, to ensure performance of the centrifuge may be effectively optimized. Further, the performance report may be provided to a personnel of the facility to address at least one of the fault and the probability of occurrence of at least one event. For instance, on considering a wastewater treatment plant that employs a centrifuge for solid-liquid separation, equipped with sensors, operational parameters such as inlet pressure, temperature, volume flow, rotational speed, and feed composition may be measured. These parameters may be continuously monitored and analyzed by the system. In one example, KPIs such as centrifugal acceleration, total solid recovery, compound solid recovery, capacity, and pressure drop may be determined. These values may then be compared to their expected values to determine a deviation in the performance of the centrifuge. In this example, the system may detect a 15% decrease in total solid recovery compared to the expected value. This deviation in performance of the centrifuge may then be compared against various threshold ranges, including design, static, statistical, and predicted dynamic thresholds. Based on such a comparison and the one or more parameters, the fault analysis model may determine that the deviation exceeds the statistical threshold range and predicts a 70% probability of a partial blockage in the centrifuge's discharge ports within 48 hours if left unaddressed. The system may then generate a performance report recommending a maintenance check within 24 hours and may include a recommended action of reducing the inlet flow rate by 10% to maintain optimal performance until maintenance can be performed.

In addition to determining a fault associated with the centrifuge and predicting the probability of occurrence of an event associated with the centrifuge, techniques of the present subject matter also determine a remaining useful life of the centrifuge based on the operational parameters, the fault determined, predicted events, and the deviation in performance. Remaining useful life may indicate the time left before a component, or a sub-system of the centrifuge reaches the end of its operational effectiveness or fails to meet specified performance criteria, thereby indicating how soon the centrifuge might breakdown without performing preventive maintenance based on the current operation of the centrifuge, or by how much would the lifecycle of the centrifuge be reduced if issues faced currently are left unaddressed. In one example, the remaining useful life may also be included in the performance report.

Therefore, techniques of the present subject matter enable real-time monitoring of the centrifuge and enhance operational efficiency by optimizing the performance of the centrifuge and reducing unexpected downtime. Minimizing unexpected downtimes further minimize operational costs and improve the overall efficiency of the facility. Further, continuous assessment of centrifuge performance leads to timely interventions and adjustments in operational parameters to achieve optimal performance. Additionally, techniques of the present subject matter pre-empt fault occurrence by predicting the probability of faults and providing actionable insights through recommendations in performance reports, thereby enabling proactive maintenance.

The above and other features, aspects, and advantages of the subject matter will be explained with regard to the following description and accompanying figures. It should be noted that the description and figures merely illustrate the principles of the present subject matter along with examples described herein and should not be construed as a limitation to the present subject matter. It is thus understood that various arrangements may be devised that, although not explicitly described or shown herein, embody the principles of the present disclosure. Moreover, all statements herein reciting principles, aspects, and examples thereof, are intended to encompass equivalents thereof. Further, for the sake of simplicity, and without limitation, the same numbers are used throughout the drawings to reference like features and components.

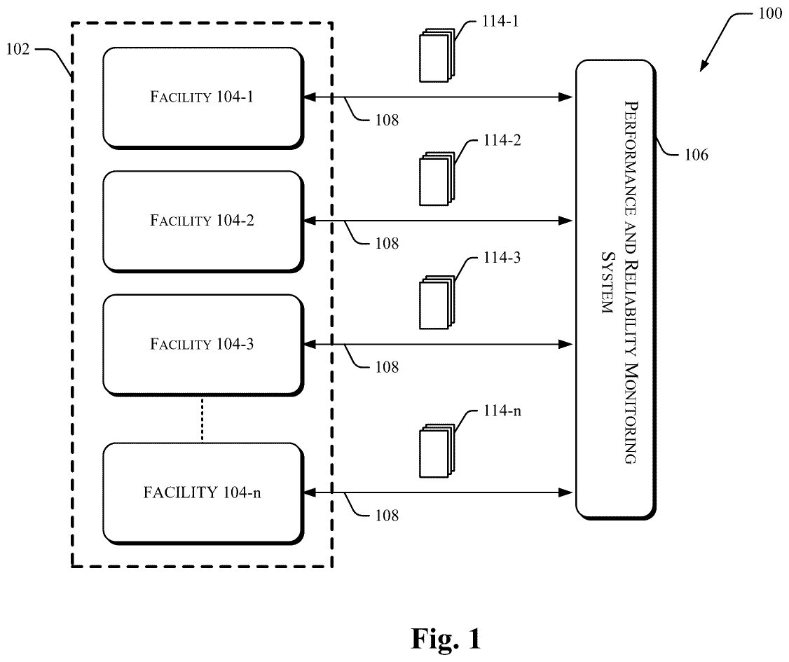

FIG. 1 illustrates a supply chain network environment 100, in accordance with an example implementation of the present subject matter. In one example, the supply chain network environment 100 may include a supply chain network 102 including multiple facilities, 104-1, 104-2, 104-3, . . . 104-n, collectively and alternatively referred to as multiple facilities 104 or facility 104. For example, but not limited to, the facility 104 may be an industrial plant, a wastewater treatment plant, an oil and gas refinery, a food and beverage processing unit, a chemical processing unit, a pharmaceutical manufacturing unit, and the like. In one example, the multiple facilities 104 may be distributed across various locations in the supply chain network 102.

Each facility of the multiple facilities 104 may include a facility management system (not shown in the figure). In one example, the facility management system may be employed in each facility 104 for optimizing performance and reliability of a centrifuge operating in the facility 104. In one example, the facility management system may be part of a source device (not shown in the figure), where the source device may be an Internet of things (IOT) device, a computing device, a personal computer, a laptop, a tablet, a mobile phone, and the like. In another example, the facility management system may be hosted on a server (not shown in the figure) that may communicate with the source device.

In one example, the facility management system of each of the multiple facilities 104 may be communicatively coupled to a performance and reliability monitoring system 106. The facility management systems and the performance and reliability monitoring system 106 may communicate over a network 108. The network 108 may be a wireless network or a combination of a wired and wireless network. The network 108 can also include a collection of individual networks, interconnected with each other and functioning as a single large network, such as the Internet. Examples of such individual networks include, but are not limited to, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), Public Switched Telephone Network (PSTN), Long Term Evolution (LTE), and Integrated Services Digital Network (ISDN). Depending on the terminology, the communication network includes various network entities, such as gateways and routers; however, such details have been omitted to maintain the brevity of the description.

Further, the performance and reliability monitoring system 106 may be implemented in any computing system, such as a storage array, a server, a desktop or a laptop, a computing device, a distributed computing system, or the like. Although not depicted, the performance and reliability monitoring system 106 may include other components, such as interfaces to communicate over the network or with external storage or computing devices, display, input/output interfaces, operating systems, applications, data, and other software or hardware components (not depicted for the sake of brevity).

In one example, the performance and reliability monitoring system 106 may obtain data 114-1, 114-2, 114-3, . . . , 114-n, collectively referred to as data 114, from multiple facilities 104-1, 104-2, 104-3, . . . 104-n, respectively. In one example, the data 114 generated by the multiple facilities 104, amongst other information, may include information associated with the operations, equipments, and processes of the facility. For example, in a facility, such as an industrial plant, the data 114 could indicate different types of equipments commissioned in the plant, maintenance logs of the various equipments, centrifuges, sub-systems associated with the centrifuges, operating conditions for each of these equipments, personnel data, faults that frequently occur in the plant, symptoms associated with different types of faults, root cause analysis reports for previous faults, equipment repair records, energy consumption patterns during normal conditions and fault conditions, equipment risk assessment reports, facility performance, the costs associated with various equipment, processes and personnel of the facility, and the like.

Upon receiving the data 114 from the facilities 104 within the supply chain network 102, the performance and reliability monitoring system 106 may analyze the data 114 to optimize the performance and reliability of a centrifuge operating in a facility 104, as well as on the supply chain network 102. In one example, the performance and reliability monitoring system 106 may obtain one or more operational parameters associated with the centrifuge to determine multiple key performance indicators (KPIs). The multiple KPIs determined may be compared to an expected KPI computed based on Original Equipment Manufacturer (OEM) data and historical data to assess the performance of the centrifuge. In one example, upon determining the deviation in performance of the centrifuge, and based on the one or more operational parameters that are obtained in real-time and a plurality of threshold ranges, a fault associated with the centrifuge may be determined or a probability of occurrence of at least one event associated with the centrifuge may be predicted. On determining at least one of a fault and the probability of occurrence of at least one event, a performance report including one or more recommended actions to address the fault or the predicted event may be generated. The performance report may include details such as the specific fault detected, the probability of the predicted event occurring, potential causes of the fault or event, and suggested maintenance or operational adjustments to mitigate the issue. In one example, the performance report may also include historical trends of relevant KPIs, comparisons to similar centrifuges in the network, and estimated impact on overall facility productivity if the fault or event is not addressed. The performance report may then be provided a personnel of the facility to address the fault or the predicted event. In one example, the performance report may be provided to the personnel of the facility through automated email alerts, displaying notifications on a dashboard interface, or integrating with existing facility management systems, and the like.

Therefore, techniques of the present subject matter facilitate real-time monitoring of the centrifuge and improve the operational efficiency by optimizing the performance of the centrifuge and reducing unexpected downtime, thereby minimizing operational costs and improving the overall efficiency of the facility. Techniques of the present subject matter also pre-empt the occurrence of a fault by accurately predicting the probability of occurrence of a fault and also provide actionable insights through specific recommendations in its performance reports, thereby enabling proactive maintenance. Additionally, techniques of the present subject matter also facilitate estimating remaining useful life of the centrifuge which aids in long-term maintenance planning and asset management.

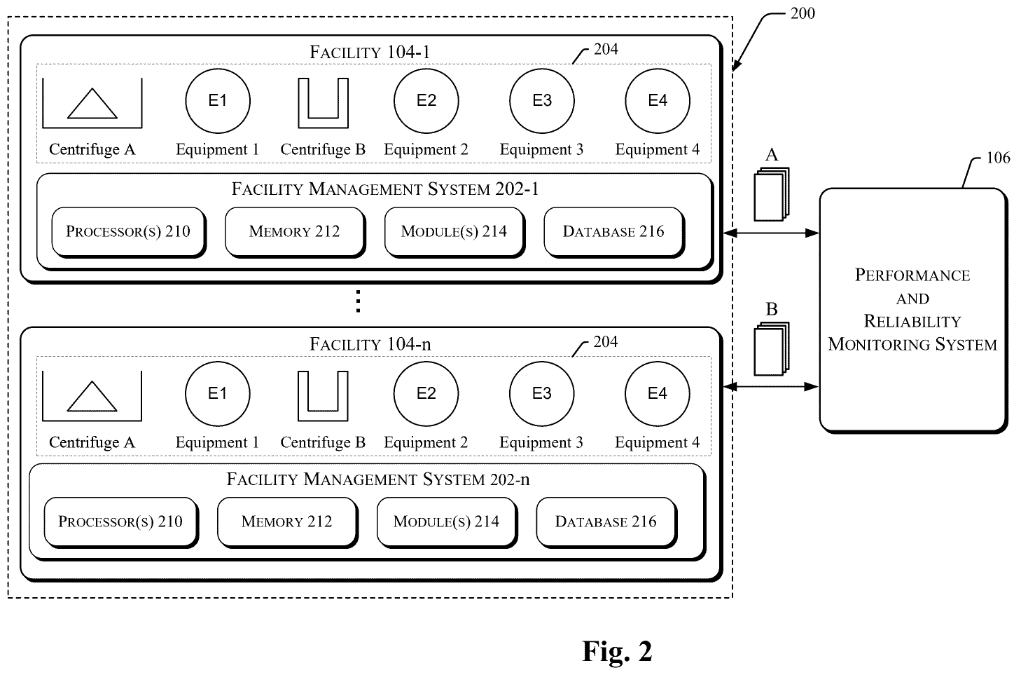

FIG. 2 illustrates an example supply chain network 102, in accordance with an example implementation of the present subject matter. In one example, the supply chain network 200 depicts Facility 104-1 and Facility 104-n communicatively coupled to the performance and reliability monitoring system 106. For the sake of simplicity, the following description has been predominantly discussed with reference to Facility 104-1 and Facility 104-n of the supply chain network 200, communicatively coupled to the performance and reliability monitoring system 106. However, similar principles may be applicable to all facilities of a supply chain network 200 coupled to the performance and reliability monitoring system 106.

In one example, Facility 104-1 of the supply chain network 200 may be located in a first geographical location and Facility 104-n may be located in a second geographical location of the supply chain network 200. Each of the facilities, Facility 104-1, and Facility 104-n, may include a facility management system 202-1, 202-n, respectively. In one example, the facility management system 202-1 of Facility 104-1 and the facility management system 202-n of Facility 104-n may be communicatively coupled to the performance and reliability monitoring system 106.

Further, Facility 104-1 and Facility 104-n within the supply chain network 102 may include a plurality of equipments depicted as Centrifuge A, Centrifuge B, Equipment 1, Equipment 2, Equipment 3, and Equipment 4, collectively referred to as equipment 204, associated with the various operations of the facility. In one example, centrifuge A of Facility 104-1 may include multiple components and sub-systems such as a bearing sub-system, a lubrication sub-system, power transmission equipment, a gearbox sub system, and the like. Additionally, equipments such as driver systems, control systems, starting systems, multiple interconnected subsystems, each containing multiple subcomponents may be operating in the facility.

Data A and data B from each of these equipments commissioned in Facility 104-1 and Facility 104-n may be collected by the facility management systems 202-1 and 202-n, respectively. For example, considering the example of the centrifuge A commissioned in the facility, data A collected from the centrifuge may include a wide range of parameters across the various subsystems associated with the centrifuge. This may encompass operational data such as inlet pressure, temperature, volume flow rate, and feed composition, including solid content and particle size distribution. Details regarding the centrifuge bowl such as information on rotational speed, vibration in both radial and axial directions, and bowl temperature may be included. Data such as motor current, temperature readings, gearbox temperature, vibration data, lubricant pressure, temperature, flow rate, and reservoir level, and the like from one or more sub-systems of the centrifuge may be included. Further, performance parameters like centrifuge efficiency, power consumption, bowl differential speed, separation efficiency, volumetric throughput, pressure drop across the centrifuge, and the like may be obtained. Additionally, maintenance-related data such as running hours, number of starts and stops, and time since last overhaul may be recorded.

For the sake of simplicity, the following description has been discussed with reference to the facility management system 202-1 of Facility 104-1, of the supply chain network 102. However, it may be understood that similar principles may be applicable to all other facilities 104 of the supply chain network 102. In one example, the facility management system 202-1 includes a processor 210 and a memory 212. The processor(s) 210 may be provided through the use of dedicated hardware as well as hardware capable of executing instructions. When provided by a processor, the functions may be provided by a single dedicated processor, by a single shared processor, or by a plurality of individual processors, some of which may be shared. Moreover, explicit use of the term “processor” would not be construed to refer exclusively to hardware capable of executing instructions, and may implicitly include, without limitation, digital signal processor (DSP) hardware, network processor, application specific integrated circuit (ASIC), field programmable gate array (FPGA), read only memory (ROM) for storing instructions, random access memory (RAM), non-volatile storage. Other hardware, standard and/or custom, may also be included. The memory 212 may include any computer-readable medium including, for example, volatile memory (e.g., RAM), and/or non-volatile memory (e.g., EPROM, flash memory, etc.).

The facility management system 202-1 may further include modules 214, such as an asset monitoring module, process flow control module, data integration module, and the like (not shown). In one example, the modules 214 may be implemented as a combination of hardware and firmware. In examples described herein, such combinations of hardware and firmware may be implemented in several different ways. For example, the firmware for the module 214 may be processor 210 executable instructions stored on a non-transitory machine-readable storage medium and the hardware for the module 214 may include a processing resource (for example, implemented as either a single processor or a combination of multiple processors), to execute such instructions.

In the present examples, the machine-readable storage medium may store instructions that, when executed by the processing resource, implement the functionalities of the modules 214. In such examples, the facility management system 202-1 may include the machine-readable storage medium storing the instructions and the processing resource to execute the instructions. In other examples of the present subject matter, the machine-readable storage medium may be located at a different location but accessible to the facility management system 202-1 and the processor(s) 210.

The facility management system 202-1 may further include a database 216, that serves, amongst other things, as a repository for storing data A that may be fetched, processed, received, or generated by the modules. For example, but not limited to, data A associated with the equipments 204 of Facility 104-1 may include information regarding the sub-systems of the centrifuge, type of centrifuge, design data of the centrifuge, components of the sub-systems of the centrifuge, performance metrics of each of these sub-systems and sub-components such as operational efficiency, energy consumption rates, and output quality, data associated with condition monitoring of each component of the facility, such as vibration levels, temperature readings, feed flow rates, rotational speed, inlet pressure, inlet temperature, lubricant data, voltage measurements, current measurements, etc., energy consumption of different equipments utilized in the facility, maintenance records, historical maintenance logs, historical operating conditions, failure patterns, root cause analysis for faults that have occurred in the past, and the like.

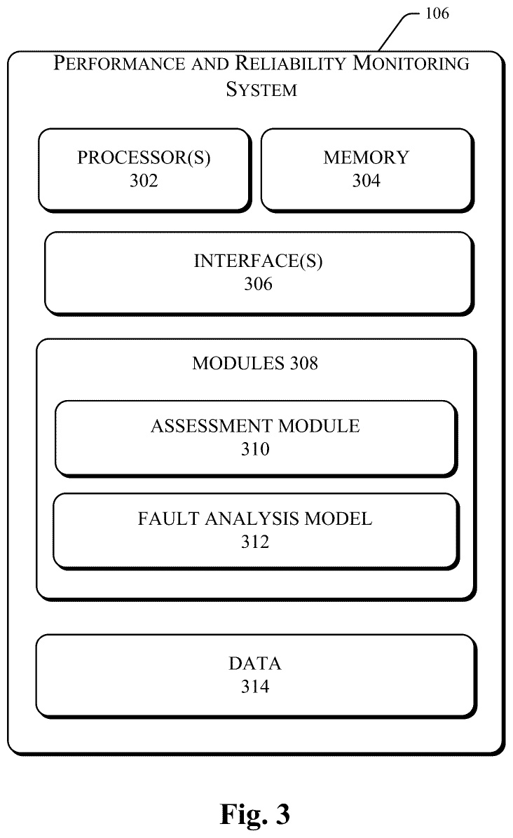

In one example, the facility management system 202a of Facility 104-1 may integrate and store all the data A collected from multiple equipments in the database 216 of the facility management system 202a. Similarly, data B from the plurality of equipments 204 associated with Facility 104-n of the supply chain network 102 may be collected and stored in the facility management system 202-n. In one example, data A from Facility 104-1, data B from Facility 104-n of the supply chain network 102 may be communicated to the performance and reliability monitoring system 106. Based on such data obtained from the facility management systems 202-1 and 202-n, the performance and reliability monitoring system 106 may analyze the data to optimize the performance and reliability of the centrifuge. The performance and reliability monitoring system 106 has been discussed with reference to FIG. 3.

FIG. 3 illustrates a performance and reliability monitoring system 106, in accordance with an example implementation of the present subject matter. The performance and reliability monitoring system 106, alternatively referred to as system 106, is to accurately optimize the performance and reliability of a centrifuge operating in a facility. The facility, such as an industrial facility, may include equipment such as centrifuges, and multiple sub-systems associated with centrifuges such as bearing systems, transmission systems, lubrication systems, feed systems, drivers, control systems, cooling systems, and the like. Any deviation in the performance of the centrifuge or sub-systems of the centrifuge, spanning across multiple facilities may be analyzed to optimize performance of the centrifuge, predict the probability of occurrence of an event associated with the centrifuge, and detect faults associated with the centrifuge at an early stage to enhance the reliability and efficiency of the centrifuge, the facility in which the centrifuge is operating in, as well as the supply chain network.

In one example, the system 106 may include a processor 302 and a memory 304 coupled to the processor 302. The functions of functional block labelled as “processor(s)”, may be provided through the use of dedicated hardware as well as hardware capable of executing instructions. When provided by a processor, the functions may be provided by a single dedicated processor, by a single shared processor, or by a plurality of individual processors, some of which may be shared. Moreover, explicit use of the term “processor” would not be construed to refer exclusively to hardware capable of executing instructions, and may implicitly include, without limitation, digital signal processor (DSP) hardware, network processor, application specific integrated circuit (ASIC), field programmable gate array (FPGA), read only memory (ROM) for storing instructions, random access memory (RAM), non-volatile storage. Other hardware, standard and/or custom, may also be included. Further, an interface(s) 306 may allow the connection or coupling of the system 106 with one or more other devices (say devices or systems within the supply chain network), through a wired (e.g., Local Area Network, i.e., LAN) connection or through a wireless connection (e.g., Bluetooth®, Wi-Fi). The interface(s) 306 may also enable intercommunication between different logical as well as hardware components of the system 106.

The memory 304 may include any computer-readable medium including, for example, volatile memory (e.g., RAM), and/or non-volatile memory (e.g., EPROM, flash memory, etc.).

The system 106 may further include modules 308, such as an assessment module 310. The module(s) 308, in one example, may be implemented as a combination of hardware and firmware. In examples described herein, such combinations of hardware and firmware may be implemented in several different ways. For example, the firmware for the module may be processor executable instructions stored on a non-transitory machine-readable storage medium and the hardware for the module may include a processing resource (for example, implemented as either a single processor or a combination of multiple processors), to execute such instructions.

In the present examples, the machine-readable storage medium may store instructions that, when executed by the processing resource, implement the functionalities of the module(s) 308. In such examples, the system 106 may include the machine-readable storage medium storing the instructions and the processing resource to execute the instructions. In other examples of the present subject matter, the machine-readable storage medium may be located at a different location but accessible to the performance and reliability monitoring system 106 and the processor 302.

The system 106 may further include data 314, that serves, amongst other things, as a repository for storing data that may be fetched, processed, received, or generated by the modules 308. The data 314 may include centrifuge equipment data, data corresponding to the systems used in each facility, OEM data for all centrifuges and related equipment, maintenance logs for centrifuges, fault tree signatures specific to centrifuge operation, various threshold and pre-determined data for centrifuge performance, health status data corresponding to various centrifuges across multiple facilities, feed characteristics, operational parameters, performance metrics, vibration data, bearing temperature readings, lubrication system data, historical fault patterns, and the like. In an example, the data 314 may be stored in the memory 304.

In one example, the assessment module 310 of the performance and reliability monitoring system 106 may monitor multiple operational parameters corresponding to a centrifuge. An operational parameter corresponding to the centrifuge may be a physical parameter of the centrifuge, such as feed inlet pressure, liquid outlet pressure, feed volumetric flow, feed solid percent, solid product mass flow, rotational speed, and the like. The one or more operational parameters may be obtained from one or more sensors, or data collection devices coupled to the centrifuge or one or more sub-systems associated with the centrifuge. In one example, the operational parameters may be obtained and monitored in real-time. In another example, the operational parameters may be obtained at pre-determined intervals, for example, every 15 minutes or every two hours, and the like. In one example, the operational parameters associated with the centrifuge may include operational parameters obtained from the centrifuge, as well as various sub-systems associated with the centrifuge, multiple components and sub-components associated with the various sub-systems of the centrifuge, such as centrifuge bearing system, centrifuge lube oil system, centrifuge gearbox system, and the like. Although the detailed description has been predominantly described with reference to the centrifuge in general, it would be understood that principles of the present subject matter would be applicable to any one of the sub-systems, components, and sub-components of the centrifuge, and is not to be construed as a limitation.

The operational parameters may be monitored to determine multiple key performance indicators (KPIs) associated with the centrifuge. Key Performance Indicators (KPIs) are quantifiable measures that are used to evaluate the centrifuge's performance. In one example, in addition to the operational parameters associated with the centrifuge, a design specification of the centrifuge may also be considered to determine KPIs associated with the centrifuge. For example, for a bird solid centrifuge, operational parameters such as inlet pressure, inlet temperature, inlet volume flow/mass flow, rotational speed, inlet feed data, and the like, and design specification such as a radius of the bowl, bowl length, and weir height may be considered to determine multiple KPIs corresponding to the bird solid centrifuge. Similarly, for a Laval sediment centrifuge, in addition to the operational parameters, design specifications such as number of discs, an inner radius of the disc, an outer radius of the disc, a slant angle of the disc, and a slant length of the disc, may be considered to determine the KPIs associated with the Laval sediment centrifuge. In one example, but not limited to, key performance indicators may be determined based on mathematical equations corresponding to force balance, mass balance, energy balance, and the like, associated with the centrifuge.

To assess the performance of the centrifuge, in one example, the key performance indicators determined from the operational parameters may be compared with an expected KPI to determine a deviation in performance of the centrifuge. For example, an operating KPI, such as total solid recovery, may be computed for the centrifuge at a first instance of time. The total solid recovery computed for the first instance of time may then be compared with an expected total solid recovery, to assess the performance of the centrifuge at the first instance of time. The expected KPI may be computed from original equipment manufacturer (OEM) specifications and performance data to establish a performance baseline for the centrifuge. Any deviation in the operating KPI computed for the centrifuge from the expected KPI may be characterized as a deviation in the performance of the centrifuge. In another example, the expected KPI may be predicted based on OEM specifications and historical performance data associated with centrifuge. Historical performance data, amongst other information, may include data associated with past operating parameters, historical expected key performance indicators associated with the centrifuge, faults that have occurred in the past, historical maintenance logs, deviations in performance that have occurred in the past and the causes responsible for such deviations, and the like. Based on such data, a performance baseline for the centrifuge may predicted in real-time from which, the excepted KPI may be determined. The operating KPI may then be compared with the expected KPI computed dynamically in real-time, thereby enhancing the accuracy in determining a deviation in performance of the centrifuge. For example, a bird solid centrifuge may be operating with an inlet pressure of 2.5 bar, inlet temperature of 65° C., inlet volume flow of 15 m³/h, rotational speed of 3200 rpm, and inlet feed solid concentration of 8% by weight. Based on these operational parameters and the centrifuge's design specifications, the calculated separation efficiency may be 92%. However, the expected separation efficiency for these operating conditions may be dynamically predicted in real-time based on OEM specifications and historical performance data, where the historical performance data may include past operating parameters, previously expected key performance indicators, past fault occurrences, historical maintenance logs, and prior performance deviations with their associated causes. Based on such data, a real-time performance baseline may be established, from which an expected separation efficiency of 95% may be determined. The decrease in separation efficiency by 3% computed by comparing the separation efficiency of 92% and the dynamically predicted 95% expected efficiency may be characterized as the deviation in the performance of the centrifuge.

On determining the deviation in performance, a fault analysis model 312 of the system 106 may either determine a fault associated with the centrifuge or predict a probability of occurrence of at least one event associated with the centrifuge. In one example, the fault analysis model 312 may be trained to assess the deviation in performance of the centrifuge, the operational parameters, and multiple threshold ranges, based on which either a fault associated with the centrifuge may be determined or the probability of occurrence of an event may be predicted.

For example, but not limited to, the multiple threshold ranges may include a design threshold range, a static threshold range, a statistical threshold range, and a predicted dynamic threshold range. In one example, the design threshold range may be determined based on a structural design of the centrifuge. The static threshold range may be determined based on a specification design of the centrifuge based on Original Equipment Manufacturer (OEM) data and control system limits which may be pre-determined for monitoring the centrifuge. Further, the statistical threshold range may be determined based on statistical computation of historical data, utilizing techniques standard deviation computation and average computation, and the like. In one example, an upper limit and a lower limit for the statistical threshold range may be determined based on empirical correlations and machine learning. The predicted dynamic threshold range may be determined based on the operational parameters and historical data. In one example, the fault analysis model 312 may establish a baseline for operation of the centrifuge based on historical data associated with the centrifuge, such as past operational parameters, past deviations in performance of the centrifuge, past failure patterns of the centrifuge. Based on the operational parameters obtained in real-time and the baseline established, the dynamic threshold range for monitoring the centrifuge may be predicted. In one example, techniques of machine learning and correlation using pattern recognition may be utilized to predict the dynamic threshold range.

In one example, the deviation in performance of the centrifuge may be monitored in real-time. When the deviation in performance of the centrifuge is monitored to be beyond any one of the multiple threshold ranges, an anomaly associated with the centrifuge may be detected. For example, if the deviation in performance is beyond any one of the multiple threshold ranges by a value of 2 or 4 sigma, an anomaly may be detected. In one example, the deviation in performance of the centrifuge may be monitored at pre-determined time intervals, for example, every 5 minutes, 15 minutes, or one hour, where the pre-determined time intervals may be determined based on the degree of deviation, or operating condition of the centrifuge, and the like. In another example, the deviation in performance may be monitored continuously.

Further, in one example, a degree of deviation in the performance of the centrifuge may be assessed. Based on the degree of deviation and the anomaly detected, the fault analysis model 312 may determine the fault associated with the centrifuge and predict the possibility of occurrence of an event. For example, if the deviation in performance of the centrifuge is substantial, a fault associated with the centrifuge may be determined. In another example, for comparatively less severe deviations from the expected range, the fault analysis model 312 may predict the probability of an event that may occur in the future. This distinction between a fault and the predicted event may be based on a predetermined threshold range corresponding to the operational parameter or the KPI being monitored. For instance, a 15% decrease in separation efficiency may be classified as a fault requiring immediate attention, while a 5% decrease might trigger a prediction of a potential clogging event in the coming days or weeks, thereby facilitating both immediate fault detection and proactive maintenance based on predicted events, enhancing the overall reliability and efficiency of the centrifuge operation.

Further, in one example, the probability of occurrence of an event may be predicted based on a scale, for example but not limited to, a scale of 1-5, where 1 would indicate the least probability of occurrence of an event and 5 would indicate the highest probability of occurrence of an event. In one example, the scale may be further refined to increase the accuracy of prediction. Additionally, the fault analysis model 312 may determine an impact of an event associated with the probability of occurrence of the said event. For example, impact in terms of operational efficiency, production loss, repair costs, or safety risks may be determined.

Based on the probability of occurrence of an event and the associated impact, in one example, a severity of the event may also be predicted. The severity of the fault or event may be graded, where an increasing grade of severity may correspond to a progressively greater impact on the centrifuge's operation and performance. In one example, but not limited to, the severity of the event predicted may also be associated with an estimated possible down time of the centrifuge. The downtime of the centrifuge may be estimated based on factors such as repair complexity, spare parts availability, maintenance team readiness, and the like. The downtime prediction may be expressed in various time units, such as hours or days, and may include a range to account for uncertainties in the repair process. For instance, the severity of the fault may be graded on a scale of 1 to 6 where grade 1 may indicate a minimal severity fault requiring no downtime, Grade 2 may represent a minor fault potentially causing less than 6 hours of downtime, Grade 3 may signify a fault necessitating between 6 to 24 hours of downtime, Grade 4 may denote a fault potentially requiring 1-3 days of downtime, Grade 5 may indicate a serious fault that may lead to 3 days to a week of downtime, and Grade 6 may represent a critical fault potentially causing 1 week to a month of downtime, and the like.

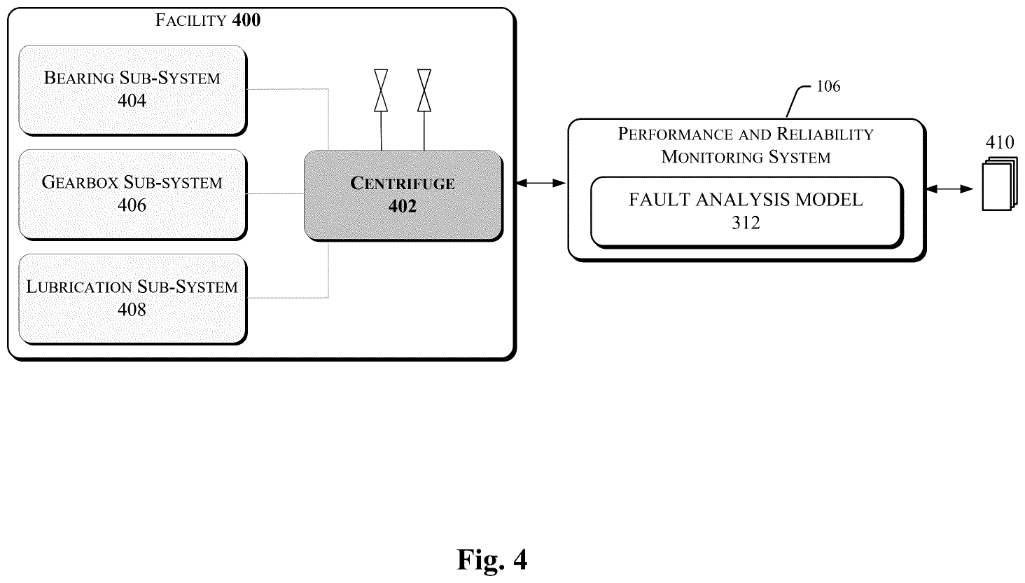

The following example of predicting the probability of occurrence of an event as depicted in FIG. 4 is only to elucidate the principles of the present subject matter and is not to be construed as a limitation. FIG. 4 illustrates an example of performance monitoring of a centrifuge in an industrial plant 400, in accordance with an example implementation of the present subject matter. In one example, the industrial plant 400 may be equipped with a centrifuge 402, a bearing sub-system 404 of the centrifuge, a gearbox sub-system 406 of the centrifuge, a lubrication sub-system 408 of the centrifuge, and the like. In one example, on monitoring the gearbox sub-system 406, a deviation in performance in the gearbox temperature from the expected values may be observed. Based on this deviation and other operational parameters, the fault analysis model 312 of the performance and reliability monitoring system 106 may predict one or more events associated with the deviation in performance. For instance, the probability of occurrence of a first event such as failure in the end bearings due to mechanical issues, a second event such as failure in the end bearings due to gearbox oil pressure, or third event such as failure in the end bearings due to gearbox oil temperature, and the like may be predicted. In one example, fault analysis model 312 may grade the probability of occurrence of the first event, the second event, and the third event, on a scale of 1-5, where 5 may indicate a high probability and 1 may indicate a low probability. In this example, the probability of occurrence of each of these events may be graded as 4. In addition to predicting the probability of occurrence, the fault analysis model 312 may also assess the potential impact and severity of each of these events. The severity may be graded on a similar 1-5 scale. For the given example, the first and second events (failure due to mechanical issues and oil pressure) may have an impact grade of 4, potentially resulting in downtime of 1-3 days, while the third event (failure due to oil temperature) may have a severity grade of 3, potentially causing downtime between 6 hours to 1 day. This predictive analysis may allow facility operators to prioritize maintenance activities, allocate resources effectively, and take pre-emptive actions to mitigate potential failures. The system may use this information to generate recommendations in the performance report 410, such as suggesting specific maintenance checks or adjustments to operating parameters to reduce the risk of these predicted events.

On continuing with description of FIG. 3, in one example, the fault analysis model 312 may determine a remaining useful life of the centrifuge. In one example, the remaining useful life of the centrifuge may be determined based on the fault, occurrence of a first set of events from amongst the at least one events, one or more symptoms associated with the fault, the deviation in performance of the centrifuge, the one or more operational parameters, historical patterns of degradation associated with the centrifuge, and the like. Remaining useful life may be an estimate of the time left before a component, system, or equipment reaches the end of its operational effectiveness or fails to meet specified performance criteria. In one example, the remaining useful life of the centrifuge may be determined in real-time. In another example, the remaining useful life of the centrifuge may be determined at predetermined time intervals, for example, every 2 hours, and the like. In one example, the remaining useful life determined for the centrifuge may be provided to personnel of the facility, such as an operations manager, indicating how soon the centrifuge might breakdown without performing preventive maintenance based on the current operation of the centrifuge, or by how much would the lifecycle of the centrifuge would be reduced due to the issues faced currently are left unaddressed. In one example, one or more recommended actions may also be provided to the personnel, thereby aiding in accurate scheduling of maintenance actions, planning replacements, and optimizing operational strategies to maximize utilization of the centrifuge while minimizing unexpected failures.

In one example, in order to train the fault analysis model, historical data associated with multiple centrifuges and sub-systems of the centrifuge may be utilized for better accuracy of identification, detection, and prediction of events. In one example, the fault analysis model 312 may be trained to correlate the anomaly detected with at least one of a cause, an effect, and a failure mode associated with the centrifuge based on historical data. Historical data, amongst other information, may include data associated with past operating parameters, past static thresholds, past design thresholds, past statistical thresholds, historical expected key performance indicators associated with the centrifuge, faults that have occurred in the past, symptoms associated with such faults, faults associated with one or more sub-systems of the centrifuge and the symptoms corresponding to the faults associated with the sub-systems, causes associated with fault, effects of the fault, one or more corrective actions performed in the past to mitigate a fault, historical maintenance logs, event logs, deviations in performance that have occurred in the past and the causes responsible for such deviations, and the like. In one example, all this data may be correlated to define rules, based on which the fault analysis model 312 is to either determine a fault or predict the probability of occurrence of an event. In one example, the cause, the effect, and the failure modes may also be included in a performance report generated by the fault analysis model, in addition to the one or more recommended actions. In one example, the recommended actions may include maintenance procedures, operational adjustments, or component replacements, and the like. In one example, but not limited to, machine learning techniques for advanced pattern recognition such as Advance analytical algorithm of Moving Mean Principal Component Analysis may be utilized to train the fault analysis model.

For example, an event such as a bearing failure due to a mechanical issue in a bearing system of the centrifuge may be correlated with symptoms such as high feed end bearing temperature, high feed end bearing vibration in a horizontal direction, high feed end bearing vibration in a vertical direction, and the like. These symptoms may be correlated to causes such as wear and tear of Bush/Pad, increase in bearing clearance, multiple surge events, electrical discharge, liquid slugs ingression, bearing aging, sensor bias or drift, metal to metal contact, rolling element sliding, dents in rolling element, over rolling of solid contamination, inner ring creeping on the shaft, outer ring creeping on the housing, and the like. Similarly, one or more effects such as bearing temperatures being high and bearing damage and failure modes such as fracture (spalling, cracking, seizing), deformation (deformation, embedment, uneven load patterns), wear (scoring, overheating/scuffing, abrasive wear/scratching/grooving), and erosion (erosion, cavitation, corrosion) may be correlated with the one or more parameters. Accordingly, recommended actions for such symptoms, such as checking calibration of sensors, investigating with high frequency vibration analysis, assessing likely cause and time to fail (trip) if intervention not possible, intervention options, such as reduction in speed, parts availability, and the like, checking trends to establish if the issue is due to both X and Y probes or one, inspecting bearing for wiping, internal clearances, oil coking or hotspots, changing bearing if required, and the like, may be defined. Similarly, in another example, an event such as lube oil temperature being high in a lube oil system of the centrifuge may be correlated with symptoms such as high spindle supple temperatures, high spindle return temperatures, high gearbox temperatures, high gearbox return temperatures, high spindle reservoir temperatures, high gearbox temperatures, and high lube oil temperatures, and the like. These symptoms may be correlated to causes such as TCV failure, isolation valve leak, cooler failure, cooler fouling, CW temperature anomaly, sensor bias, and the like. Similarly, effects such as oil instability, bearing overheating, high temperature and property loss, and failure modes such as TCV stem damage or seat wear, TCV actuator calibration loss, and isolation valve seat wear, and the like may be defined. Accordingly, recommended actions such as checking the calibration of sensor, checking the bypass control valve for integrity, opening both coolers and stabilizing temperature, lining walks the system to check for leaks, checking the Isolation/bypass valve of TCV, checking cooling water pumps for blockages, and ensuring strainer is clean may be defined.

Further, the fault analysis model 312 may be trained using historical data to predict the severity of potential events associated with the centrifuge. The fault analysis model 312 may be trained to grade the probability of occurrence of an event based on a scale from 1 to 5, where 1 indicates the least likelihood of an event occurring and 5 the highest, thereby facilitating anticipation of events before they occur to allow pre-emptive actions to be performed. Further, the fault analysis model 312 is also trained to assess an impact of the fault based on historical data to evaluate factors such as operational efficiency, production loss, repair costs, and safety risks. Further, based on the probability of occurrence and an associated impact of an event, the fault analysis model 312 may be trained to grade the severity of fault to predict a possible downtime that may be associated with the event ensuring that the downtime estimations are not only accurate but also specific to real-time operation of the centrifuge, thereby enhancing the reliability and efficiency of maintenance planning.

In one example, the fault analysis model 312 may generate a performance report for the centrifuge based on at least one of the determined faults and the predicted probability of occurrence of at least one event, where the performance report includes one or more recommended actions to address at least one of the fault and the probability of occurrence of at least one event. In one example, the performance report may be determined at pre-determined time intervals, for example every 1 hour, and the like. In one example, a user may set the pre-determined time intervals based on the operating condition of the centrifuge and sub-systems of the centrifuge, and the like. The performance report may also include the cause, the effect, and the failure mode associated with a predicted event and recommended actions to prevent the failure mode from occurring. For example, recommended actions such as checking the calibration of sensor, checking cooling water supply pressure, checking bypass control valve, opening both coolers to stabilize the temperature, checking cooling water pumps for blockages, ensuring the strainer is clean, checking the fan and motor integrity for an air cooler, isolating and inspecting components for malfunctioning, switching of the cooler in case of water contamination, reconditioning or replacing the oil, and the like, may be included in the performance report in accordance with the type of fault determined or the predicted event.

In one example, the performance report may be provided to a personnel of the facility to address at least one of the fault and the probability of occurrence of at least one event by performing the one or more recommended actions. For instance, the performance report may be provided to a facility manager, where the facility manager may implement the one or more recommended actions to prevent the event from occurring. Additionally, the system may continuously monitor the implementation of recommended actions and their effectiveness in addressing the identified faults or predicted events, which allows the fault analysis model 312 to refine its predictive analysis and improve the accuracy of future fault detection and event prediction. In one example, the performance report may be generated on implementation of the one or more recommended actions, which may indicate how the recommended actions have impacted the performance of the centrifuge. In one example, the performance report may include visual representations such as graphs, charts, or diagrams to illustrate changes in performance metrics over time. The performance report may also provide comparisons between current performance and historical data or industry benchmarks. In one example, the personnel may customize the information to be generated in the performance report, allowing the personnel to focus on specific areas of interest or concern. Additionally, the performance report may be also accessible through various platforms, including mobile devices, to facilitate real-time decision making and monitoring.

Therefore, techniques of the present subject matter facilitate real-time optimization of performance and reliability of the centrifuge through continuous monitoring of operational parameters and key performance indicators, early fault detection, and event prediction for proactive maintenance. Further, dynamic prediction of expected KPIs, based on real-time conditions and historical data, significantly improves the accuracy of performance assessments and event predictions.

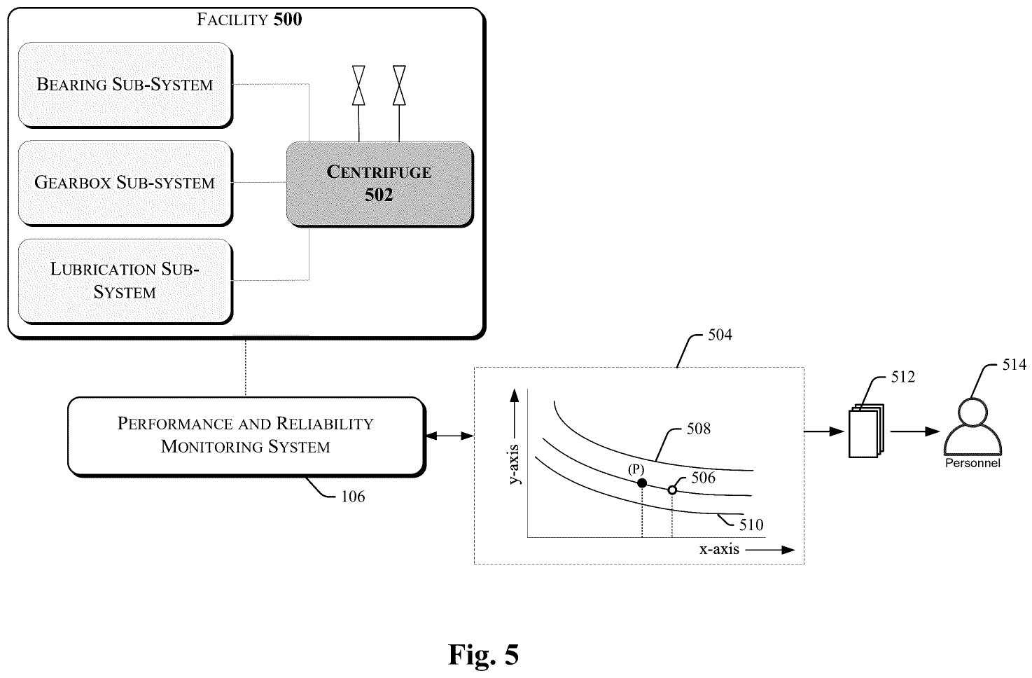

FIG. 5 illustrates an example of performance and reliability monitoring of an industrial facility 500, in accordance with an example implementation of the present subject matter. In one example, the industrial facility 500 may be a pharmaceutical plant 500, equipped with multiple centrifuges and sub-systems associated with the centrifuges. In one example, a centrifuge 502 may be used for separating active pharmaceutical ingredients. In one example, the performance and reliability monitoring system 106 may obtain operational parameters such as feed volumetric flow, inlet pressure, inlet temperature, volume flow, and rotational speed. In one example, these operational parameters may be obtained through one or more sensors associated with the centrifuge. In another example, these operational parameters may be obtained from control systems or logical units such as Distributed Control Systems (DCS), Programmable Logical Controllers (PLCs), and the like. From the operational parameters, one or more operating key performance indicators may be determined. For example, the performance and reliability monitoring system 106 may determine the operating KPI for feed solid percent to be 12%. FIG. 5 illustrates an example graph 504 representing a performance curve obtained by plotting feed solid percentage along the x-axis and feed actual volumetric flow along the y-axis. The graph 504 is merely a representation to elucidate the principles of the present subject matter and is not to be construed as a limitation. In one example, the operating KPI 506 may be compared with an expected KPI 508 for the centrifuge 502. In one example, the expected KPI 508 may be determined based on OEM specification data. In this example, the expected KPI 508 for the centrifuge may be 15%. On comparing the expected KPI 508 and the operating KPI 506, a deviation in performance of 3% may be determined in the feed solid percent KPI. In one example, this deviation in performance may be further analyzed to determine an anomaly associated with the centrifuge.

Based on the operational parameters obtained in real-time, the operating KPI 506, and historical performance data associated with the centrifuge 502, in one example, the performance and reliability monitoring system 106 may further predict the KPI value for a future point in time, such as 8 hours from the current instance when the operating KPI is computed. For example, the system 106 may predict that if no action is taken, feed solid percent will further decrease to 10% within 8 hours due to gradual bowl fouling.

In one example, the predicted KPI 510 may be included in performance report 512 provided to a personnel 514, such as a facility manager of the facility 500. This insight allows the personnel 514 to assess the operating KPI 506 and the potential changes in performance that may occur over the next 8 hours based on the predicted KPI 510. Further, based on this prediction, a new operating point (P) may be suggested to the personnel 514 along with one or more recommended actions, such as maintenance tasks, to ensure that the centrifuge operates at this new point (P) for optimal performance of the centrifuge. This proactive approach aids in maintaining continuous and efficient operation of the centrifuge, potentially preventing performance degradation or failures.

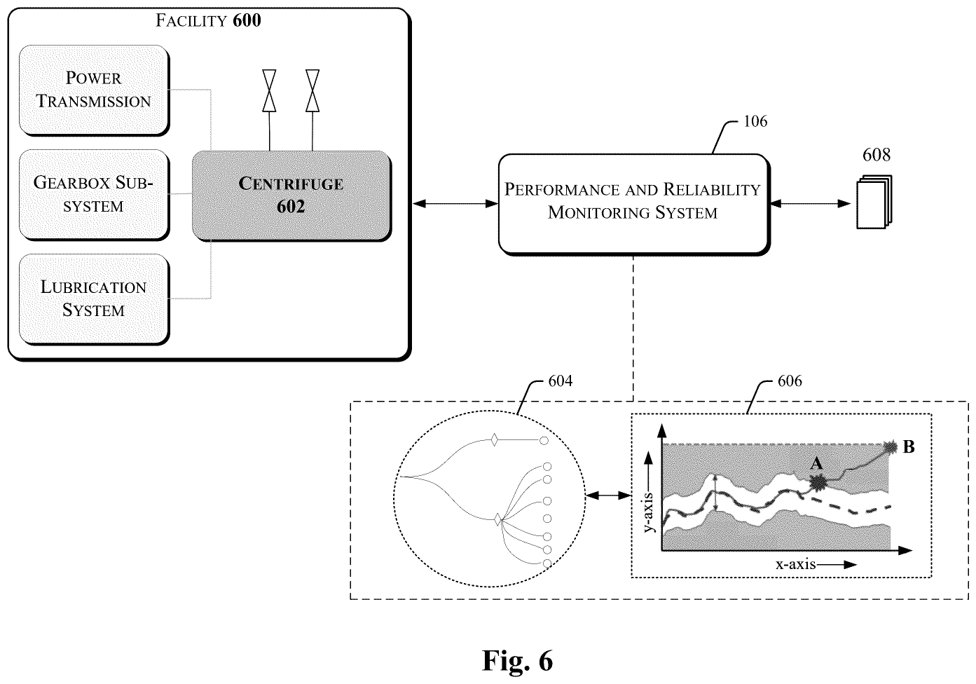

FIG. 6 illustrates another example of performance and reliability monitoring of an industrial facility 600, in accordance with an example implementation of the present subject matter. In one example, the industrial facility 600 may be a chemical processing plant 600. A centrifuge 602 of the facility 600 may be continuously monitored by the performance and reliability monitoring system 106, where the system may continuously obtain operational parameters associated with the centrifuge, such as inlet pressure, rotational speed, and feed composition to determine an operating KPI of the centrifuge. For example, a current total solid recovery of the centrifuge may be determined. Based on the operating KPI determined, a deviation in performance of the centrifuge from an expected KPI may be determined.

In one example, the fault analysis model, which is trained based on historical data, may assess deviations with respect to the operational parameters obtained in real-time. In this example, the system 106 may employ pattern recognition techniques 604 for early fault detection. In one example, the system 106 may detect subtle changes in operational parameters that historically preceded performance degradation. In one example, while the total solid recovery has not yet shown a significant deviation, the fault analysis model 312 may identify specific patterns of minor fluctuations in inlet pressure, rotational speed, and feed composition. Based on the minor fluctuations in the operational data and historical data associated with the centrifuge, the fault analysis model 312 may predict a high probability of an event occurring at point ‘A’ as depicted in graph 606. Graph 606 is plotted to depict a deviation in a key performance indicators monitored over a pre-determined time period, for example, over one week, with a value associated with the KPI being plotted along y-axis against time plotted along the x-axis. As would be understood, graph 606 is merely to illustrate principles of the present subject matter and is not to be construed as a limitation. For example, the fault analysis model 312 may predict that a partial clogging event is likely to occur within the next 48 hours if left unattended at point ‘A’. This early detection allows for proactive measures to be taken before the issue develops further. Based on this early detection, the system 106 may generate a performance report 608 with recommended preventive maintenance actions to be performed within 36-48 hours. These recommendations may include a thorough inspection of the centrifuge's discharge ports, checking the feed system for any irregularities, and potentially making minor adjustments to operating parameters, and the like. In contrast, without early fault detection capabilities, impending issues associated with the centrifuge may be unnoticed and may be only identified when they have progressed to a more advanced stage. For instance, the impeding issues may be noticed at point B of graph 606, which occurs later in time. This delayed detection may result in predicting occurrence of events that are imminent, such as a partial clogging event possibly within 24 hours, with potentially more severe consequences due to the advanced state of the issue.

By identifying potential issues at an early stage as depicted by point A in graph 606, before they cascade into significant deviations, the system 106 enables proactive maintenance strategies with an extended response window of 36-48 hours. This allows for more efficient resource allocation and less severe interventions, often requiring only minor adjustments to operating parameters rather than drastic measures like reducing feed rates. The system 106 thus maintains optimal operational efficiency by addressing potential issues early, which leads to significant cost savings through less extensive repairs, shorter maintenance periods, and reduced production losses. Moreover, techniques of the present subject matter enhance the overall lifespan of the centrifuge by preventing prolonged operation under suboptimal conditions.

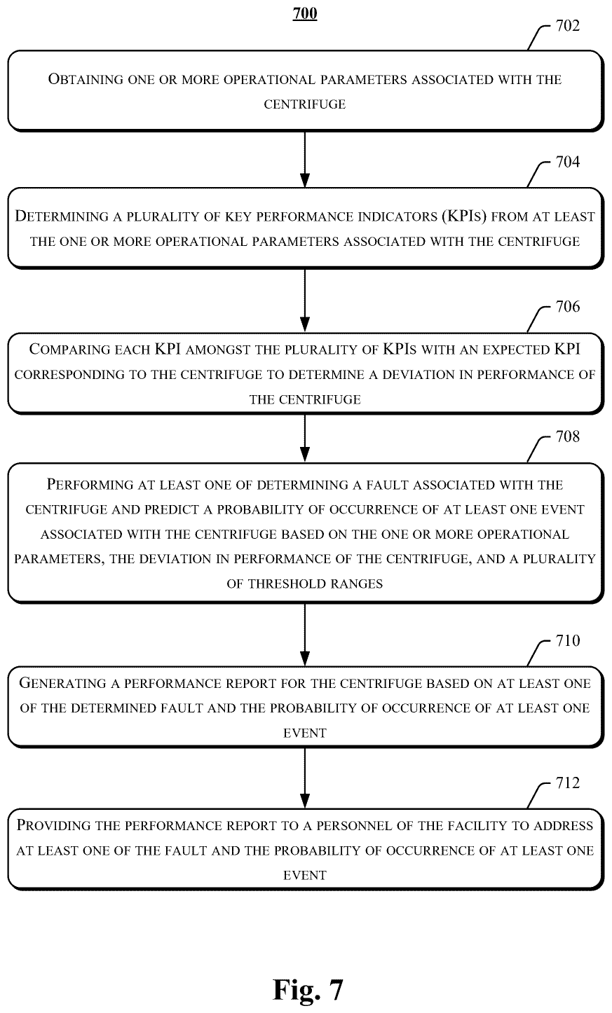

FIG. 7 illustrates an example method 700 for optimizing performance and reliability of a centrifuge operating in a facility, in accordance with an example implementation of the present subject matter. The order in which the method 700 is described is not intended to be construed as a limitation, and any number of the described method blocks can be combined in any order to implement method 700 or an alternative method. Additionally, individual blocks may be deleted from the method 700 without departing from the spirit and scope of the subject matter described herein. Furthermore, the method 700 may be implemented in any suitable hardware, computer readable instructions, firmware, or combination thereof. For discussion, the method 700 is described with reference to the implementations illustrated in FIG(S). 1-6.

At block 702, the method 700 includes obtaining one or more operational parameters associated with the centrifuge. In one example, the one or more operational parameters are obtained through one or more sensing elements coupled to the centrifuge. In another example, the one or more operational parameters may be obtained from a control system monitoring the centrifuge, such as a PLC or a DCS.

At block 704, the method 700 includes determining a plurality of key performance indicators (KPIs) from at least one or more operational parameters associated with the centrifuge. In one example, a design specification of the centrifuge may also be considered while determining the KPIs associated with the centrifuge. In one example, the KPIs may include at least centrifugal acceleration, total solid recovery, compound solid recovery, pressure drop, and volume flow.

At block 706, the method 700 includes comparing each KPI amongst the plurality of KPIs with an expected KPI corresponding to the centrifuge to determine a deviation in performance of the centrifuge. In one example, the expected KPIs may be determined from OEM data.

At block 708, the method 700 includes performing, at least one of determining a fault associated with the centrifuge and predicting a probability of occurrence of at least one event associated with the centrifuge. In one example determining the fault associated with the centrifuge and predicting the probability of occurrence of an event may be based on the one or more operational parameters, the deviation in performance of the centrifuge, and a plurality of threshold ranges. In one example, the plurality of threshold ranges includes at least one predicted dynamic threshold range. In one example, the event may be characterized by a discrepancy in operation of the centrifuge. In one example, the plurality of threshold ranges may include at least a design threshold range, a static threshold range, a statistical threshold range, and the predicted dynamic threshold range, where the design threshold range is determined based on a structural design of the centrifuge, the static threshold range is determined based on a specification design of the centrifuge based on Original Equipment Manufacturer (OEM) data, the statistical threshold range is determined based on statistical computation of historical data, and the predicted dynamic threshold range may be determined based on the operational parameters and historical data.

At block 710, the method 700 includes generating a performance report for the centrifuge. In one example, the performance report may be generated for the centrifuge based on at least one of the determined fault and the probability of occurrence of at least one event. In one example, the performance report may include one or more recommended actions to address the determined fault or the predicted event.

At block 712, the method 700 includes providing the performance report to a personnel of the facility to address the determined fault or the predicted event based on the one or more recommended actions.

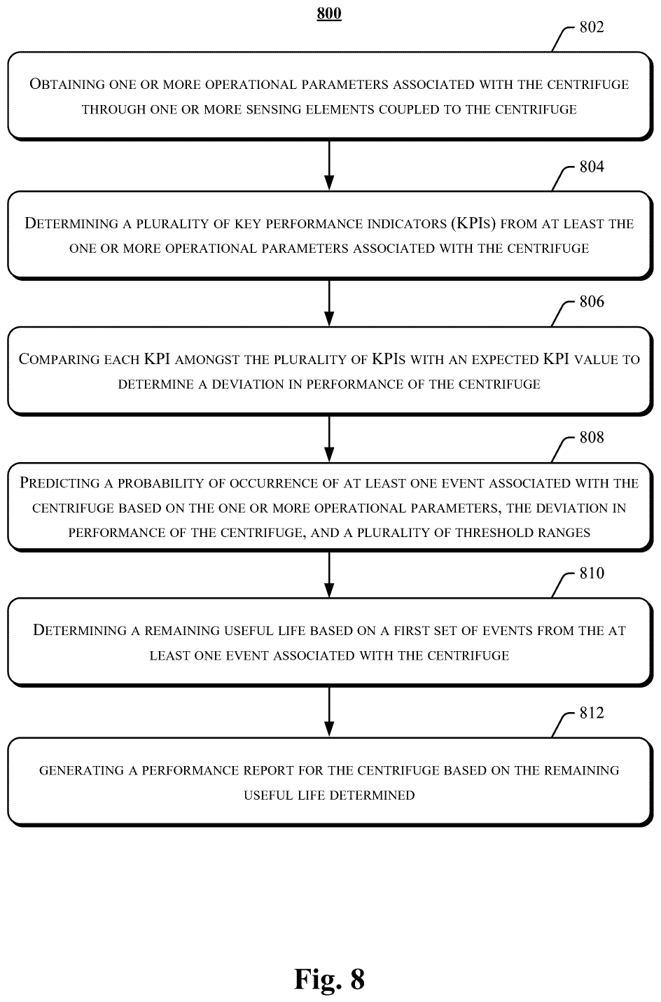

FIG. 8 illustrates another example method 800 for optimizing performance and reliability of a centrifuge operating in a facility, in accordance with an example implementation of the present subject matter. The order in which the method 800 is described is not intended to be construed as a limitation, and any number of the described method blocks can be combined in any order to implement method 800 or an alternative method. Additionally, individual blocks may be deleted from the method 800 without departing from the spirit and scope of the subject matter described herein. Furthermore, the method 800 may be implemented in any suitable hardware, computer readable instructions, firmware, or combination thereof. For discussion, the method 800 is described with reference to the implementations illustrated in FIG(S). 1-6.

At block 802, the method 800 includes obtaining one or more operational parameters associated with the centrifuge. In one example, the one or more operational parameters are obtained through one or more sensing elements coupled to the centrifuge. In another example, the one or more operational parameters may be obtained from a control system monitoring the centrifuge, such as a PLC or a DCS.

At block 804, the method 800 includes determining a plurality of key performance indicators (KPIs) from at least the one or more operational parameters associated with the centrifuge. In one example, the plurality of KPIs include at least centrifugal acceleration, total solid recovery, compound solid recovery, pressure drop, and volume flow. In one example, the plurality of KPIs are determined from at least the one or more operational parameters associated with the centrifuge and a design specification of the centrifuge.

At block 806, the method 800 includes comparing each KPI amongst the plurality of KPIs with an expected KPI value to determine a deviation in performance of the centrifuge.

At block 808, the method 800 includes predicting a probability of occurrence of at least one event associated with the centrifuge based on the one or more operational parameters, the deviation in performance of the centrifuge, and a plurality of threshold ranges, where the plurality of threshold ranges includes a predicted dynamic threshold range. In one example, the plurality of threshold ranges includes at least a design threshold range, a static threshold range, a statistical threshold range, and the predicted dynamic threshold range. In another example, the design threshold range may be determined based on a structural design of the centrifuge. The static threshold range may be determined based on a specification design of the centrifuge based on Original Equipment Manufacturer (OEM) data. Further, the statistical threshold range may be determined based on statistical computation of historical data. In one example, the predicted dynamic threshold range is predicted based on the one or more operational parameters and historical data, wherein historical data is indicative of at least past operational parameters, past deviations in performance of the centrifuge, past failure patterns of the centrifuge, and past threshold ranges for desired operation of the centrifuge. In one example, the method 800 includes monitoring the deviation in performance of the centrifuge to be beyond at least one of the plurality of threshold ranges to detect an anomaly associated with the centrifuge.

At block 810, the method 800 includes determining a remaining useful life of the centrifuge based on at least one of the one or more operational parameters, the deviation in performance of the centrifuge, and occurrence of a first set of events from amongst the at least one event. Remaining useful life may indicate the time left before a component, or a sub-system of the centrifuge reaches the end of its operational effectiveness or fails to meet specified performance criteria, thereby indicating how soon the centrifuge might breakdown without performing preventive maintenance based on the current operation of the centrifuge, or by how much would the lifecycle of the centrifuge be reduced if issues faced currently are left unaddressed At block 812, the method 800 includes generating a performance report for the centrifuge based on the remaining useful life determined, where the performance report includes one or more recommended actions to improve the remaining useful life of the centrifuge.

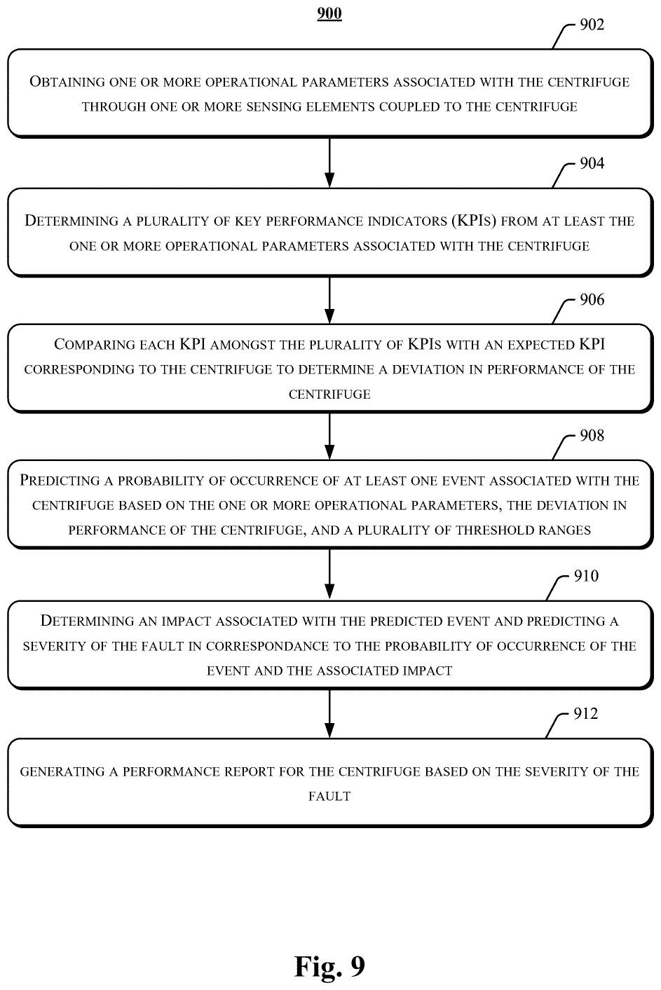

FIG. 9 illustrates another example method 900 for optimizing performance and reliability of a centrifuge operating in a facility, in accordance with an example implementation of the present subject matter. The order in which the method 900 is described is not intended to be construed as a limitation, and any number of the described method blocks can be combined in any order to implement method 900 or an alternative method. Additionally, individual blocks may be deleted from the method 900 without departing from the spirit and scope of the subject matter described herein. Furthermore, the method 900 may be implemented in any suitable hardware, computer readable instructions, firmware, or combination thereof. For discussion, the method 900 is described with reference to the implementations illustrated in FIG(S). 1-6.

At block 902, the method 900 includes obtaining one or more operational parameters associated with the centrifuge. In one example, the one or more operational parameters are obtained through one or more sensing elements coupled to the centrifuge. In another example, the one or more operational parameters may be obtained from a control system monitoring the centrifuge, such as a PLC or a DCS.

At block 904, the method 900 includes determining a plurality of key performance indicators (KPIs) from at least the one or more operational parameters associated with the centrifuge. In one example, a design specification of the centrifuge may also be considered while determining the KPIs associated with the centrifuge. In one example, the KPIs may include at least centrifugal acceleration, total solid recovery, compound solid recovery, pressure drop, and volume flow.

At block 906, the method 900 includes comparing each KPI amongst the plurality of KPIs with an expected KPI corresponding to the centrifuge to determine a deviation in performance of the centrifuge. In one example, the expected KPIs may be determined from OEM data.

At block 908, the method 900 includes predicting a probability of occurrence of at least one event associated with the centrifuge based on the one or more operational parameters, the deviation in performance of the centrifuge, and a plurality of threshold ranges, where the plurality of threshold ranges includes a predicted dynamic threshold range. In one example, the plurality of threshold ranges includes at least a design threshold range, a static threshold range, a statistical threshold range, and the predicted dynamic threshold range. In another example, the design threshold range may be determined based on a structural design of the centrifuge. The static threshold range may be determined based on a specification design of the centrifuge based on Original Equipment Manufacturer (OEM) data. Further, the statistical threshold range may be determined based on statistical computation of historical data. In one example, the predicted dynamic threshold range is predicted based on the one or more operational parameters and historical data, wherein historical data is indicative of at least past operational parameters, past deviations in performance of the centrifuge, past failure patterns of the centrifuge, and past threshold ranges for desired operation of the centrifuge.

At block 910, the method 900 includes determining an impact associated with the predicted event and predicting a severity of the fault in correspondence to the probability of occurrence of the event and the associated impact. For example, impact in terms of operational efficiency, production loss, repair costs, or safety risks may be determined. Based on the probability of occurrence of an event and the associated impact, in one example, a severity of the event may also be predicted. The severity of the fault or event may be graded, where an increasing grade of severity may correspond to a progressively greater impact on the centrifuge's operation and performance.

At block 912, the method 900 includes generating a performance report for the centrifuge based on the severity of the fault, where the performance report includes one or more recommended actions to mitigate the probability of occurrence of the event.

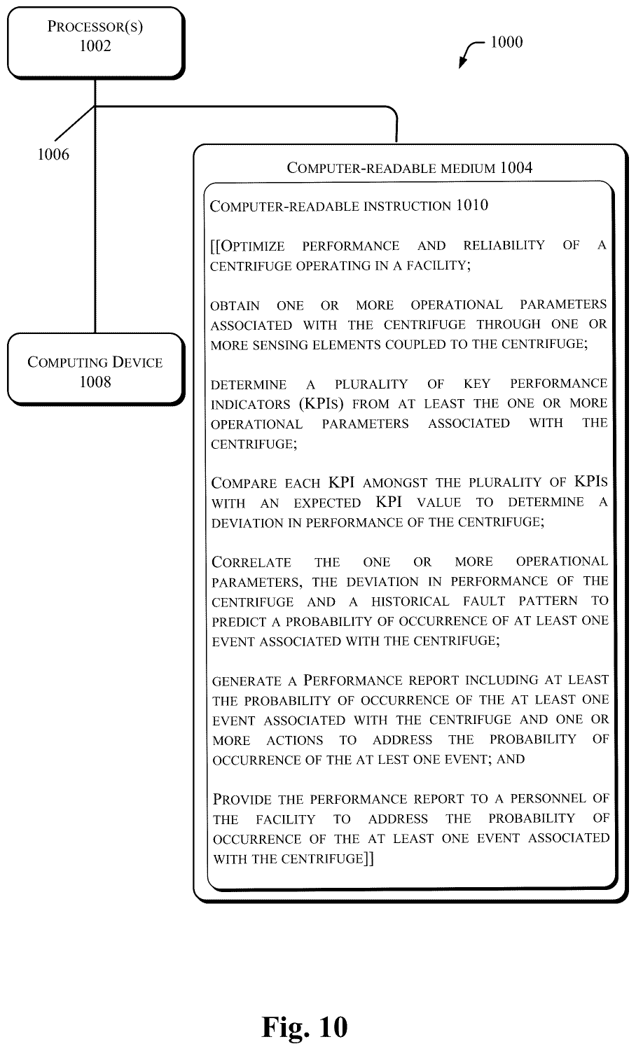

FIG. 10 illustrates a non-transitory computer-readable medium for optimizing performance and reliability of a centrifuge operating in a facility, in accordance with an example of the present subject matter. In an example, the computing environment 1000 includes processor 1002 communicatively coupled to a non-transitory computer readable medium 1004 through communication link 1006. In an example implementation, the computing environment 1000 may be for example, the system 106 for optimizing performance and reliability of a centrifuge. In an example, the processor 1002 may have one or more processing resources for fetching and executing computer-readable instructions from the non-transitory computer readable medium 1004. The processor 1002 and the non-transitory computer readable medium 1004 may be implemented, for example, in the system for optimizing the performance and reliability of the system.

The non-transitory computer readable medium 1004 may be, for example, an internal memory device or an external memory. In an example implementation, the communication link 1006 may be a network communication link, or other communication links, such as a PCI (Peripheral component interconnect) Express, USB-C (Universal Serial Bus Type-C) interfaces, I2C (Inter-Integrated Circuit) interfaces, and the like. In an example implementation, the non-transitory computer readable medium 1004 includes a set of computer readable instructions 1010 which may be accessed by the processor 1002 through the communication link 1006 and subsequently executed for optimizing the performance and reliability of the centrifuge. The processor(s) 1002 and the non-transitory computer readable medium 1004 may also be communicatively coupled to a computing device 1008 over the network.

Referring to FIG. 10, in an example, the non-transitory computer readable medium 1004 includes computer readable instructions 1010 that cause the processor 1002 to obtain one or more operational parameters associated with the centrifuge through one or more sensing elements coupled to the centrifuge. The instructions 1010 may further cause the processor 1002 to determine a plurality of key performance indicators (KPIs) from at least the one or more operational parameters associated with the centrifuge. Further, the instructions 1010 may cause the processor 1002 to compare each KPI amongst the plurality of KPIs with an expected KPI value to determine a deviation in performance of the centrifuge.

The instructions 1010 may further cause the processor 1002 to correlate the one or more operational parameters, the deviation in performance of the centrifuge, and a historical fault pattern to predict a probability of occurrence of at least one event associated with the centrifuge. In one example, the historical fault pattern may be indicative of one or more failure modes, one or more symptoms associated with the one or more failure modes, correlation of data between past operational parameters, past deviations in performance of the centrifuge and the one or more failure modes.

Further, the instructions 1010 may cause the processor 1002 to generate a performance report including at least the probability of occurrence of the at least one event associated with the centrifuge and one or more actions to address the probability of occurrence of the at least one event. The instructions 1010 may further cause the processor 1002 to issue the performance report to a personnel of the facility to address the probability of occurrence of the at least one event associated with the centrifuge. In one example, the instructions 1010 may further cause the processor 1002 to determine a remaining useful life of the centrifuge based on at least one of the one or more operational parameters, the deviation in performance of the centrifuge, and occurrence of a first set of events from amongst the at least one event.

Although examples of the present subject matter have been described in language specific to methods and/or structural features, it is to be understood that the present subject matter is not limited to the specific methods or features described. Rather, the methods and specific features are disclosed and explained as examples of the present subject matter.

We claim:

1. A method for optimizing performance and reliability of a centrifuge operating in a facility, the method comprising:
obtaining, by an assessment module, one or more operational parameters associated with the centrifuge through one or more sensing elements coupled to the centrifuge;
determining, by the assessment module, a plurality of key performance indicators (KPIs) from at least the one or more operational parameters associated with the centrifuge;
comparing, by the assessment module, each KPI amongst the plurality of KPIs with an expected KPI corresponding to the centrifuge to determine a deviation in performance of the centrifuge;
performing, by a fault analysis model, at least one of determining a fault associated with the centrifuge and predicting a probability of occurrence of at least one event associated with the centrifuge based on the one or more operational parameters, the deviation in performance of the centrifuge, and a plurality of threshold ranges, wherein the plurality of threshold ranges includes at least one predicted dynamic threshold range, and wherein the event is characterized by a discrepancy in operation of the centrifuge;
generating, by the fault analysis model, a performance report for the centrifuge based on at least one of the determined fault and the probability of occurrence of at least one event, wherein the performance report includes one or more recommended actions to address at least one of the fault and the probability of occurrence of at least one event; and
providing, by the fault analysis model, the performance report to a personnel of the facility to address at least one of the fault and the probability of occurrence of at least one event.

2. The method of claim 1 comprises determining, by the fault analysis model, a remaining useful life of the centrifuge based on at least one of the one or more operational parameters, the deviation in performance of the centrifuge, and occurrence of a first set of events from amongst the at least one event.

3. The method of claim 1 comprises monitoring, by the fault analysis model, the deviation in performance of the centrifuge to be beyond at least one of the plurality of threshold ranges to detect an anomaly associated with the centrifuge.

4. The method of claim 3 comprises correlating, by the fault analysis model, the anomaly detected with at least one of a cause, an effect, and a failure mode associated with the centrifuge based on historical data to predict the probability of occurrence of at least one event associated with the centrifuge.

5. The method of claim 1 comprises determining, by the fault analysis model, a remaining useful life of the centrifuge based on the fault, one or more symptoms associated with the fault, the deviation in performance of the centrifuge, and the one or more operational parameters.

6. The method of claim 1 comprises determining, by the fault analysis model, an impact associated with at least one of the determined fault and the probability of occurrence of at least one event predicted.

7. The method of claim 1, wherein the predicted dynamic threshold range is predicted based on the one or more operational parameters and historical data, wherein historical data is indicative of at least past operational parameters, past deviations in performance of the centrifuge, past failure patterns of the centrifuge, and past threshold ranges for desired operation of the centrifuge.

8. The method of claim 1, wherein the plurality of KPIs include at least centrifugal acceleration, total solid recovery, compound solid recovery, pressure drop, and volume flow.

9. A system for optimizing performance and reliability of a centrifuge operating in a facility, the system comprising:
an assessment module to:
obtain one or more operational parameters associated with the centrifuge through one or more sensing elements coupled to the centrifuge;
determine a plurality of key performance indicators (KPIs) from at least the one or more operational parameters associated with the centrifuge; and
compare each KPI amongst the plurality of KPIs with an expected KPI value to determine a deviation in performance of the centrifuge;
a fault analysis model to:
predict a probability of occurrence of at least one event associated with the centrifuge based on the one or more operational parameters, the deviation in performance of the centrifuge, and a plurality of threshold ranges, wherein the plurality of threshold ranges includes a predicted dynamic threshold range and wherein the event is characterized by a discrepancy in operation of the centrifuge;
generate a performance report for the centrifuge based on the probability of occurrence of at least one event, wherein the performance report includes one or more recommended actions to address the probability of occurrence of at least one event; and
provide the performance report to a personnel of the facility to address the probability of occurrence of at least one event, wherein the fault analysis model is trained using historical data including one or more faults, symptoms corresponding to the one or more faults associated with one or more sub-systems of the centrifuge, one or more actions performed to overcome the faults, past operational parameters and past deviations in performance of the centrifuge.

10. The system of claim 9, wherein the plurality of KPIs include at least centrifugal acceleration, total solid recovery, compound solid recovery, pressure drop, and volume flow.

11. The system of claim 9, wherein the plurality of threshold ranges include at least a design threshold range, a static threshold range, a statistical threshold range, and the predicted dynamic threshold range, wherein the design threshold range is determined based on a structural design of the centrifuge, the static threshold range is determined based on a specification design of the centrifuge based on Original Equipment Manufacturer (OEM) data, the statistical threshold range is determined based on statistical computation of historical data.

12. The system of claim 9, wherein the fault analysis model is to monitor the deviation in performance of the centrifuge to be beyond at least one of the plurality of threshold ranges to detect an anomaly associated with the centrifuge.

13. The system of claim 12, wherein the fault analysis model is to correlate the anomaly detected with at least one of a cause, an effect, and a failure mode associated with the centrifuge based on historical data to predict the probability of occurrence of at least one event associated with the centrifuge.

14. The system of claim 12, wherein the fault analysis model is to determine a remaining useful life of the centrifuge based on at least one of the one or more operational parameters, the deviation in performance of the centrifuge, and occurrence of a first set of events from amongst the at least one event.

15. The system of claim 9, wherein the plurality of KPIs are determined from at least the one or more operational parameters associated with the centrifuge and a design specification of the centrifuge.

16. The system of claim 9, wherein the fault analysis model is to determine an impact associated with the probability of occurrence of at least one event predicted.

17. The system of claim 9, wherein the predicted dynamic threshold range is predicted based on the one or more operational parameters and historical data, wherein historical data is indicative of at least past operational parameters, past deviations in performance of the centrifuge, past failure patterns of the centrifuge, and past threshold ranges for desired operation of the centrifuge.

18. A non-transitory computer-readable medium comprising instructions for optimizing performance and reliability of a centrifuge operating in a facility, the instructions being executable by a processor to:
obtain one or more operational parameters associated with the centrifuge through one or more sensing elements coupled to the centrifuge;
determine a plurality of key performance indicators (KPIs) from at least the one or more operational parameters associated with the centrifuge;
compare each KPI amongst the plurality of KPIs with an expected KPI value to determine a deviation in performance of the centrifuge;
correlate the one or more operational parameters, the deviation in performance of the centrifuge and a historical fault pattern to predict a probability of occurrence of at least one event associated with the centrifuge;
generate a performance report including at least the probability of occurrence of the at least one event associated with the centrifuge and one or more actions to address the probability of occurrence of the at least one event; and
provide the performance report to a personnel of the facility to address the probability of occurrence of the at least one event associated with the centrifuge.

19. The non-transitory computer-readable medium as claimed in claim 18, wherein the instructions being executable by a processor are to further determine a remaining useful life of the centrifuge based on at least one of the one or more operational parameters, the deviation in performance of the centrifuge, and occurrence of a first set of events from amongst the at least one event.

20. The non-transitory computer-readable medium as claimed in claim 18, wherein the historical fault pattern is indicative of one or more failure modes, one or more symptoms associated with the one or more failure modes, correlation of data between past operational parameters, past deviations in performance of the centrifuge and the one or more failure modes.
